(19) United States
(12) Patent Application Publication
(10) Pub. No.: US 2019/0184769 A1
(43) Pub. Date: Jun. 20, 2019

(54) PNEUMATIC TIRE AND PNEUMATIC TIRE AND RIM ASSEMBLY

(71) Applicant: SUMITOMO RUBBER INDUSTRIES, LTD., Hyogo (JP)

(72) Inventors: Naoki YUKAWA, Hyogo (JP); Toshiaki SUZUKI, Hyogo (JP); Takuya SATO, Hyogo (JP)

(73) Assignee: SUMITOMO RUBBER INDUSTRIES, LTD., Hyogo (JP)

(21) Appl. No.: 16/209,482

(22) Filed: Dec. 4, 2018

(30) Foreign Application Priority Data
Dec. 19, 2017 (JP) 2017-242950

(51) Int. Cl. B60C 19/00

(52) U.S. Cl. CPC B60C 19/002

(57) ABSTRACT

The present invention is directed to a pneumatic tire which includes a tread portion having a tread inner surface provided with a noise damper. The noise damper includes sponge members arranged in a tire circumferential direction. Each sponge member includes an inner surface facing radially inwardly, wherein the inner surface of each sponge member includes protrusions protruding radially inward and recesses recessed radially outward, and the protrusions and the recesses are arranged alternately.

### BACKGROUND ART

### Field of the Disclosure

The present disclosure relates to a pneumatic tire, and a tire and rim assembly capable of reducing road noise.

### Description of the Related Art

A road noise is known as one of the tire noises. A primary cause of the road noise is resonance vibrations of air generated in the tire cavity. To reduce such resonance vibrations of air, the following Patent document 1 has proposed a pneumatic tire which includes a tread portion provided with a sponge member on a tread inner surface.

However, further reduction in road noise generated by tires has been required in view of recent quiet vehicles.

### Patent Document 1

Japanese Patent No. 3622957

### SUMMARY OF THE DISCLOSURE

In view of the above problems in the conventional art, the present disclosure has a primary object to provide a pneumatic tire, and a tire and rim assembly capable of reducing road noise further.

According to one aspect of the disclosure, a pneumatic tire includes a tread portion having a tread inner surface provided with a noise damper. The noise damper includes sponge members arranged in a tire circumferential direction. Each sponge member includes an inner surface facing radially inwardly, wherein the inner surface of each sponge member includes protrusions protruding radially inward and recesses recessed radially outward, and the protrusions and the recesses are arranged alternately.

In another aspect of the disclosure, the tread portion may further include a belt layer, wherein an axial width of each sponge member may be in a range of from 19% to 90% of an axial width of the belt layer.

In another aspect of the disclosure, a maximum thickness of each sponge member may be in a range of from 10 to 25 mm.

In another aspect of the disclosure, the sponge members may be arranged at regular intervals in the tire circumferential direction.

In another aspect of the disclosure, in each sponge member, differences in height between the protrusions and the recesses may be equal to or more than 5 mm.

In another aspect of the disclosure, in each sponge member, the protrusions and the recesses may be arranged alternately in the tire circumferential direction.

In another aspect of the disclosure, in each sponge member, the protrusions may be continuous over an entire axial width of the sponge member at a constant height.

In another aspect of the disclosure, in each sponge member, the recesses may be continuous over an entire axial width of the sponge member at a constant height.

In another aspect of the disclosure, in each sponge member, an arrangement pitch of the protrusions is greater than an axial width of the sponge member.

In another aspect of the disclosure, in each sponge member, at least one of edges of the sponge member in the tire circumferential direction may be formed as one of the recesses.

In another aspect of the disclosure, a pneumatic tire and rim assembly includes the pneumatic tire as mentioned above and a rim on which the pneumatic tire is mounted, wherein total volume of the sponge members is in a range of from 0.9% to 12.8% of a tire cavity volume enclosed by the pneumatic tire and the rim.

### BRIEF DESCRIPTION OF THE DRAWINGS

FIG. 1 is a cross-sectional view of a tire/rim assembly in accordance with an embodiment of the disclosure;

FIG. 2 is a cross-sectional view of a pneumatic tire under a standard state;

FIG. 3 is a perspective view of a sponge member,

FIG. 4 is a circumference sectional view of the tire/rim assembly along the tire equator C;

FIGS. 5A and 5B are perspective views of sponge members in accordance with other embodiments;

FIG. 6 is a perspective view of another embodiment of the sponge member;

FIGS. 7A and 7B are perspective views of sponge members of examples; and

FIG. 8 is a perspective view of a sponge member of a comparative example.

### DESCRIPTION OF THE PREFERRED EMBODIMENTS

An embodiment of the present disclosure will be explained below with reference to the accompanying drawings.

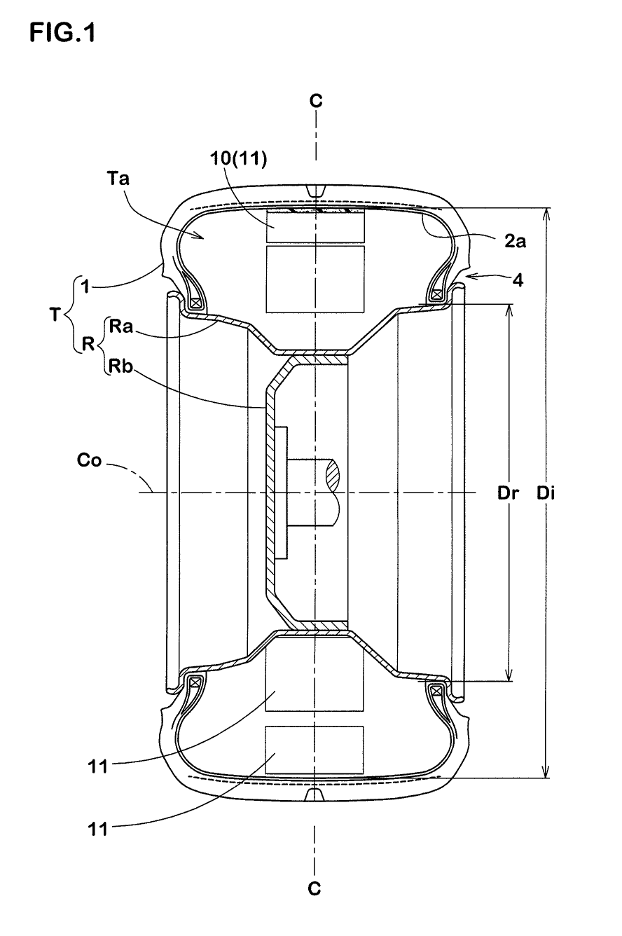

FIG. 1 illustrates a cross-sectional view of a tire/rim assembly (hereinafter, simply referred to as “assembly”) T in accordance with an embodiment of the disclosure. As illustrated in FIG. 1, the assembly T includes a rim R and a pneumatic tire (hereinafter, simply referred to as “tire”) 1 which is mounted on the rim R. In this embodiment, as a preferred embodiment, a passenger car tire in which quiet is strongly required is illustrated. Note that the present disclosure may be embodied as different kinds of tires 1, e.g., directed to motorcycle, light truck, heavy-weight vehicle and the like.

The assembly T forms a tire cavity Ta enclosed by the rim R and the tire 1 when the tire 1 is mounted on the rim R.

The rim R according to the embodiment includes an annular rim main body Ra on which two bead portions 4 of the tire 1 are mounted, and a circular disc Rb for fixing the rim main body Ra to an axle, and the rim R is configured to be a standard rim having a conventional structure.

As used herein, the standard rim is a wheel rim officially approved for each tire by standards organizations on which the tire 1 is based, wherein the standard rim is the “standard rim” specified in JATMA, the “Design Rim” in TRA, and the “Measuring Rim” in ETRTO, for example.

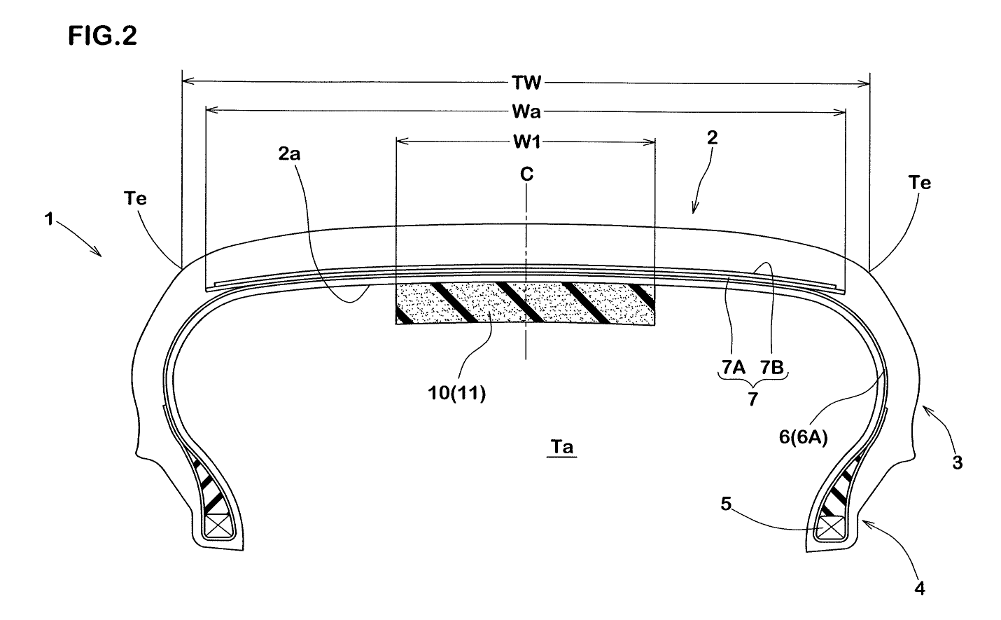

FIG. 2 illustrates a cross-sectional view of the tire 1 under a standard state. As illustrated in FIG. 2, the tire 1 according to the embodiment has a tubeless structure which includes a tread portion 2, axially spaced two sidewall portions 3 extending radially inward from both the respective both ends of the tread portions, and two bead portions 4 each positioned radially inward of each sidewall portion 3.

As used herein, the standard state is such that the tire 1 is mounted on the standard rim (the rim R) with a standard pressure but is loaded with no tire load. Unless otherwise noted, dimensions of respective portions of the tire 1 are values measured under the standard state.

As used herein, the standard pressure is a standard pressure officially approved for each tire by standards organizations on which the tire 1 is based, wherein the standard pressure is the “maximum air pressure” in JATMA, the maximum pressure given in the “tire Load Limits at Various Cold Inflation Pressures” table in TRA, and the “Inflation Pressure” in ETRTO, for example.

In this embodiment, the tire 1 includes a carcass 6 extending between bead cores 5 each disposed in a respective one of the bead portions 4 through the tread portion 2 and the sidewall portions 3, and a belt layer 7 disposed radially outside the carcass 6.

The carcass 6 includes at least one carcass ply 6A (one ply in the embodiment). The carcass ply 6A includes carcass cords embedded in a topping rubber, wherein the carcass cords are oriented at angles of from 75 to 90 degrees with respect to the tire equator C, for example.

The belt layer 7 is disposed radially outside the carcass 6 within the tread portion 2. The belt layer 7 includes at least two, in this embodiment, two belt plies 7A and 7B arranged in the tire radial direction. The belt plies 7A and 7B, for example, each includes belt cords embedded in a topping rubber. Note that a conventional band layer may be disposed radially outside the belt layer 7.

An axial width Wa of the belt layer 7 is not particularly limited, but is preferably in a range of from 60% to 110% of the tread width TW.

The tread width TW is the axial distance between tread edges Te. The tread edges Te are defined as axially outermost edges of the ground contacting patch of the tread portion 2 which occurs under a standard loaded condition. The standard loaded condition is such that the tire 1 is mounted on the standard rim R with the standard pressure and is loaded with a standard tire load when the camber angle of the tire is zero.

As used herein, the standard tire load is a tire load officially approved for each tire by standards organizations in which the tire 1 is based, wherein the standard tire load is the “maximum load capacity” in JATMA, the maximum value given in the above-mentioned table in TRA, the “Load Capacity” in ETRTO, for example.

The tire 1 according to the embodiment includes a noise damper 10 provided on a tread inner surface 2a of the tread portion 2. The noise damper 10, in this embodiment, is configured to includes a plurality of sponge members 11 arranged in the tire circumferential direction.

In this embodiment, each sponge member 11 has a porus structure which, for example, includes a so-called sponge made of foamed rubber or plastic, and an integrated member in which synthetic fibers, plant fibers or animal fibers are interwinded.

Here, the porous structure includes not only an open-cell but also closed-cell. Such sponge members 11 can absorb sound energy generated in the tire cavity Ta effectively to suppress resonance vibrations of air, thus reducing road noise. Further, since each sponge member 11 is easy to deform, e.g., compression, bending and the like, mounting property of the tire 1 onto the rim can be ensured. For the sponge members 11, for example, open-cell type spongy member such as ether polyurethane sponge, or ester polyurethane sponge can suitably be employed.

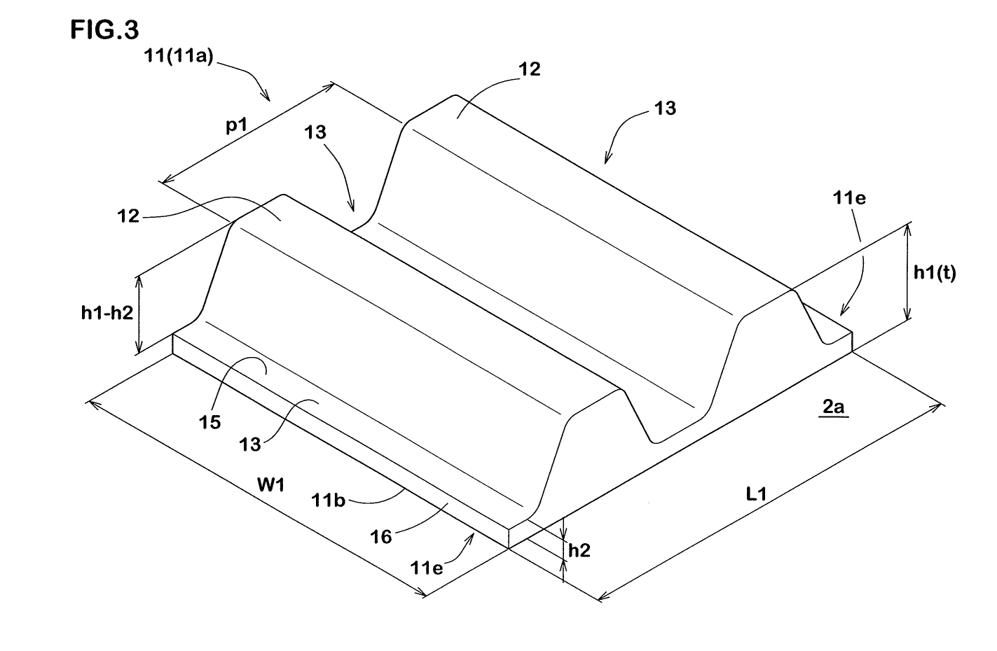

FIG. 3 illustrates a perspective view of one sponge member 11. As illustrated in FIG. 3, each sponge member 11 includes an inner surface 11a facing radially inward and an outer surface 11b facing radially outward (i.e., an opposite direction to the inner surface 11a). The outer surface 11b, in this embodiment, is fixed to the tread inner surface 2a of the tread portion 2 using a synthetic rubber adhesive, for example.

In this embodiment, the inner surface 11a includes protrusions 12 protruding radially inward and recesses 13 recessed radially outward, and the protrusions 12 and the recesses 13 are arranged alternately. In the tire 1 according to the embodiment, since the plurality of sponge members 11 each of which has the protrusions 12 and the recesses 13 alternately is arranged in the tire circumferential direction, road noise can further be reduced. This sound absorbing effect is synergistic effect which is brought about a combination of an increase of surface area of the inner surface 11a of each sponge member 11 by the protrusions 12 and the recesses 13, and an arrangement of the sponge members 11 arranged in the tire circumferential direction.

The inner surface 11a, in this embodiment, is provided with the protrusions 12 and the recesses 13 which are arranged alternately in the tire circumferential direction. Since the tire 1 is supposed to rotate around the tire axis Co (shown in FIG. 1), the air in the tire cavity Ta mainly flows along the tire circumferential direction. Thus, the protrusions 12 and the recesses 13 which are alternately in the tire circumferential direction can absorb resonance vibrations of air effectively, resulting in reducing road noise further. The inner surface 11a, in this embodiment, two protrusions 12 are provided.

In each sponge member 11, the protrusions 12 according to the embodiment are continuous over the entire axial width W1 of the sponge member 11 at a constant height h1. Further, in each sponge member 11, the recesses 13 are continuous over the entire axial width W1 of the sponge member 11 at a constant height h2. Such protrusions 12 and recesses 13 can absorb resonance vibrations effectively further.

In each sponge member 11 according to the embodiment, the inner surface 11a includes a flat surface portion 15 extending along (e.g. parallel with) the tread inner surface 2a and the protrusions 12 protruding radially inward from the flat surface portion 15, and thus the flat surface portion 15 forms the recesses 13.

In this embodiment, the protrusions 12, in a tire circumferential sectional view, has a trapezoidal shape tapering toward radially inwardly. Such protrusions 12 can exhibit better sound absorbing effect while suppressing an increase in mass of the sponge member 11. Note that the protrusions 12 are not particularly limited to such an aspect, but can be modified in various shapes, e.g., a triangular shape tapering toward radially inwardly (not illustrated), rectangular shape, wavy shape, and circular shape in the tire circumferential sectional view.

In each sponge member 11, at least one of edges 11e in the tire circumferential direction of the sponge member 11 is preferably formed as one of the recesses 13. When the one edge 11e is formed as one of the recesses 13, the edge 11e forms one recess surface and an end surface 16 connecting the recess surface and the tread inner surface 2a. Thus, in comparison with the edge 11e being formed as a protrusion 12, for example, surface area of the edge 11e becomes larger, improving absorbing resonance vibration effectively. Further, when the at least one edge 11e is formed as a recess 13, the at least one edge 11e of the sponge member 11 can be fixed to the tread inner surface 2a strongly, resulting in reducing road noise for a long term. In view of the above, both edges 11e in the tire circumferential direction of the sponge member 11 is preferably formed as recesses 13.

Preferably, in each sponge member 11, an arrangement pitch p1 of the protrusions 12 is greater than the axial width W1 of the sponge member 11. Thus, surface area of the inner surface 11a increases, resulting in suppressing resonance vibrations of air generated in the tire cavity further.

Preferably, an axial width W1 of each sponge member 11 is in a range of from 19% to 90% of the axial width Wa of the belt layer 7. When the axial width W1 of each sponge member 11 is less than 19% of the axial width Wa of the belt layer 7, it may be difficult to suppress resonance vibrations of air generated in the tire cavity. When the axial width W1 of each sponge member 11 is greater than 190% of the axial width Wa of the belt layer 7, it may be difficult to expect improving sound absorbing effect. More preferably, the axial width W1 of each sponge member 11 is in a range of from 40% to 70% of the axial width Wa of the belt layer 7.

In the same point of view, a maximum thickness (t) of each sponge members 11 is in a range of from 10 to 25 mm. In this embodiment, the maximum thickness (t) of each sponge member 11 corresponds to the heights h1 of the protrusions 12.

In each sponge member 11, the difference in height (h1-h2) between adjacent protrusion 12 and recess 13 is preferably equal to or more than 5 mm. Thus, the effect that increases surface area of the inner surface 11 a can be ensured, resulting in suppressing road noise effectively. Preferably, the difference in height (h1-h2) is equal to or less than 20 mm, in order to suppress crack of the sponge members 11 due to vibration or rotation of the tire 1.

Preferably, a circumferential length L1 of each sponge member 11 is equal to or more than 50 mm in order to further suppress resonance vibrations of air. The upper limit of the length L1 of each sponge member 11 may be given according to the number of sponge members 11.

Preferably, the sponge members 11 have specific gravity of from 0.005 to 0.06, more preferably 0.010 to 0.05, yet further preferably 0.016 to 0.05, still further preferably 0.016 to 0.035 in order to further suppress resonance vibrations of air.

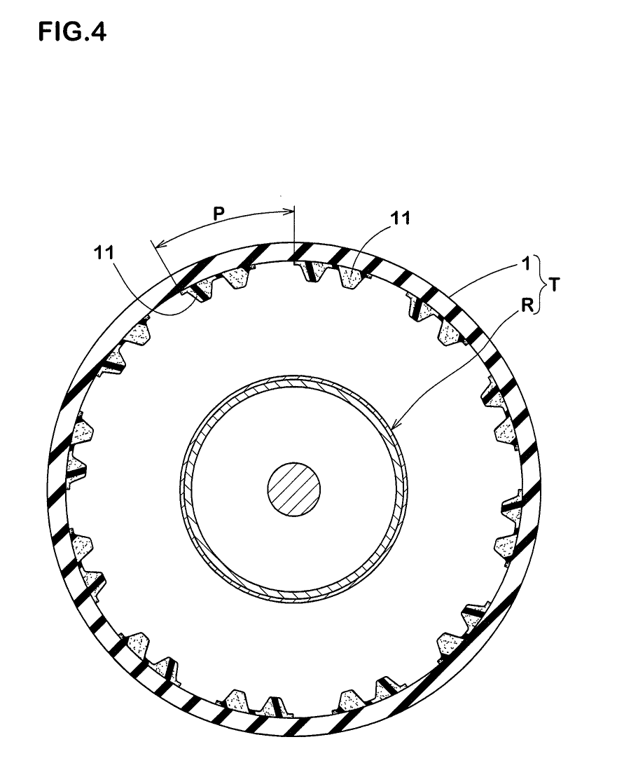

FIG. 4 illustrates a circumferential sectional view of the assembly T at the tire equator C. As illustrated in FIG. 4, the sponge member 11 are preferably arranged in the tire circumferential direction at regular intervals P so that a circumferential gap is provided between adjacent sponge members 11. In this embodiment, a circumferential length of the gap is shorter than the circumferential length L1 of each sponge member 11. This structure can suppress resonance vibrations of air further. When the sponge members 11 are arranged in such a manner, uniformity of the tire 1 can be maintained better, vibration of the tire 1 upon traveling can be suppressed. The sponge members 11, in this embodiment, are arranged in the entire tire circumferential region at the regular pitches P.

Preferably, total volume Va of the sponge members 11 is in a range of from 0.9% to 12.8% of a tire cavity volume V of the tire cavity Ta. Setting the total volume Va of the sponge members 11 being equal to or more than 0.9% of the tire cavity volume V, a sufficient reduction in road noise can be obtained. Setting the total volume Va of the sponge members 11 being equal to or less than 12.8% of the tire cavity volume V, excessive increase in mass of the tire 1 as well as unbalance of mass can be suppressed.

As used herein, the total volume Va of the sponge members 11 means the apparent entire volume of the sponge members 11 including inside bubbles. Further, the tire cavity volume V is defined under the standard state by the following approximate equation (1):

V=A×{(Di−Dr)/2+Dr}×pi (1)

where “A” represents a cross sectional area of the tire cavity Ta of the assembly T which is not provided with sponge members 11, and which is measured using a CT scanning, “Di” represents the maximum outer diameter of the tire cavity Ta as shown in FIG. 1, “Dr” represents the rim diameter, and “pi” represents circular constant.

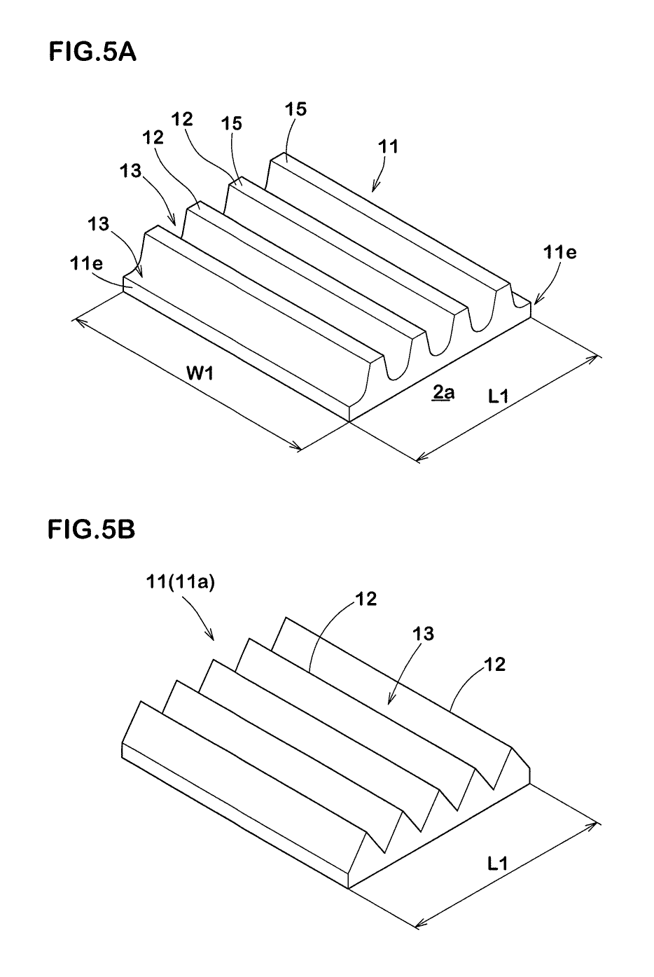

FIGS. 5A and 5B illustrate perspective view of the sponge members 11 according to other embodiments. In this embodiment as illustrated in FIG. 5A, the inner surface 11a of each sponge member 11 includes a flat surface portion 15 extending along (e.g. parallel with) the tread inner surface 2a, and recesses 13 recessed radially outwardly from the flat surface 15. Thus, the flat surface portion 15 forms a top surface of each protrusion 12. In this embodiment, the recesses 13, in the tire circumferential sectional view, each has a bottom having a circular shape. Further, both circumferential edges 11e of each sponge member 11 are configured as recesses 13. Note that the recesses 13 are not limited to such an aspect, but may be modified in various shapes, e.g., a triangular shape tapering toward radially inwardly (not illustrated), rectangular shape, and wavy shape in the tire circumferential sectional view.

In the embodiment as illustrated in FIG. 5B, in the tire circumferential sectional view, the protrusions 12 each are configured as a triangular shape tapering toward radially inwardly and the recesses 13 each are configured as a triangular shape tapering toward radially outwardly. That is, the sponge member 11 according to the embodiment is configured using only inclined surfaces with respect to the tire radial direction without having the flat surface portion extending along (e.g. parallel with) the tread inner surface 2a.

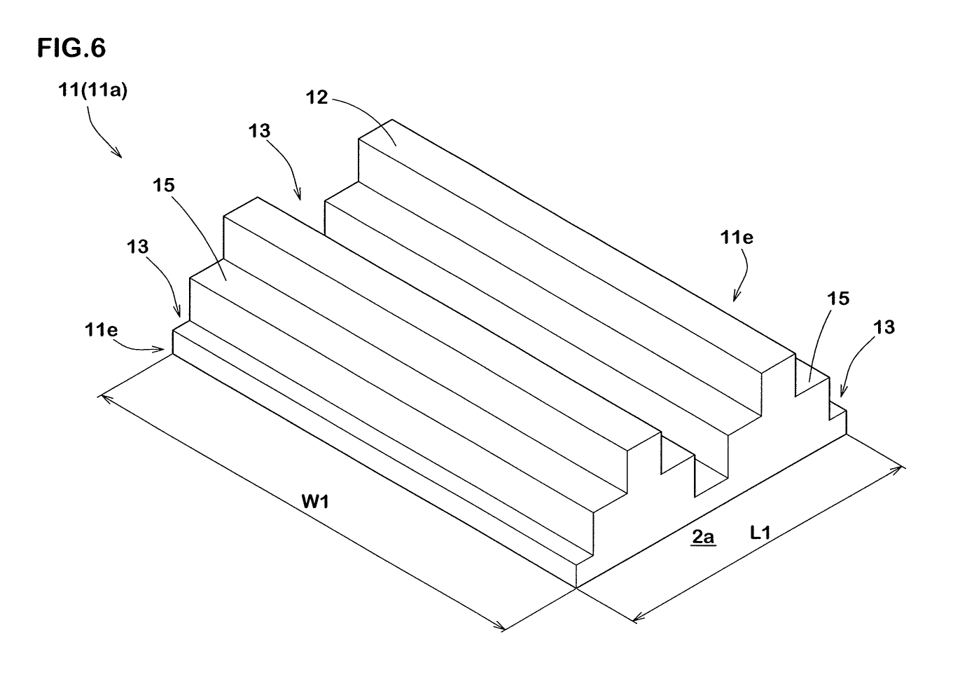

FIG. 6 illustrates a perspective view of one sponge member 11 according to yet another embodiment of the disclosure. As illustrated in FIG. 6, each sponge member 11 according to the embodiment includes the inner surface 11a which includes a standard flat surface portion 15 extending along (e.g. parallel with) the tread inner surface 2a, protrusions 12 each protruding radially inwardly from the standard flat surface portion 15, and recesses 13 recessed radially outwardly from the standard flat surface portion 15. In this embodiment, each of the protrusions 12 and the recesses 13 is configured as a rectangular shape in the tire circumferential sectional view. The circumferential both edges 11e of the sponge member 11 are configured as recesses 13, for example. Note that the protrusions 12 and the recesses 13 are not particularly limited to such an aspect, but can be modified in various aspects, e.g., a triangular shape, and a trapezoidal shape in the tire circumferential sectional view. Preferably, at a circumferential cross-sectional view of each sponge member 11, shapes of protrusions 12 are the same as the shapes of recesses 13.

While the particularly preferable embodiments of the heavy-duty pneumatic tire 1 in accordance with the present disclosure have been described in detail, the present disclosure is not limited to the illustrated embodiments but can be modified and carried out in various aspects.

### EXAMPLE

Tires of 215/55R17 having a basic structure as shown in FIG. 2 were manufactured by way of trial based on the specification in Table 1. Then, noise performance and vibration property of each test tire was tested. The common specification of each test tire and the test method are as follows:
specific gravity of sponge members: 0.031
sponge member material: ester polyurethane sponge (MARUSUZU CO., LTD., product No. E16)
tire cavity volume V: 33.8 cm³
axial width Wa of belt layer: 178 mm

Note that in Table 1, “A” represents that the sponge members are arranged at regular pitches in the entire circumference of the tire, and “B” represents that the sponge members are arranged at regular pitches in the half circumference of the tire.

### Noise Performance Test:

Each test tire was made to run on a drum tester under the following condition and the tire noise was measured by a microphone:
rim: 17×7.5 J,
inner pressure: 240 kPa,
tire load: 4.6 kN, and
speed: 60 km/hr.

Then, the peak of the sound pressure level around 205 Hz, which corresponds to resonance vibrations of air generated in the tire cavity of the tire noise, was analyzed. In Table 1, the results are shown as reduced values in the sound level (db(A)) when compared with the sound level of a tire which does not include any sponge members. The larger the value, the better.

### Vibration Property Test:

Each set of four test tires of Examples 2 and 11 was installed to a vehicle of 2000 cc displacement under the following condition:
rim: 17×7.5 J, and
inner pressure: 240 kPa.

Then, a test driver drove the vehicle on a dry asphalt test course at about 100 km/hr to evaluate the degree of vibration by his sense.

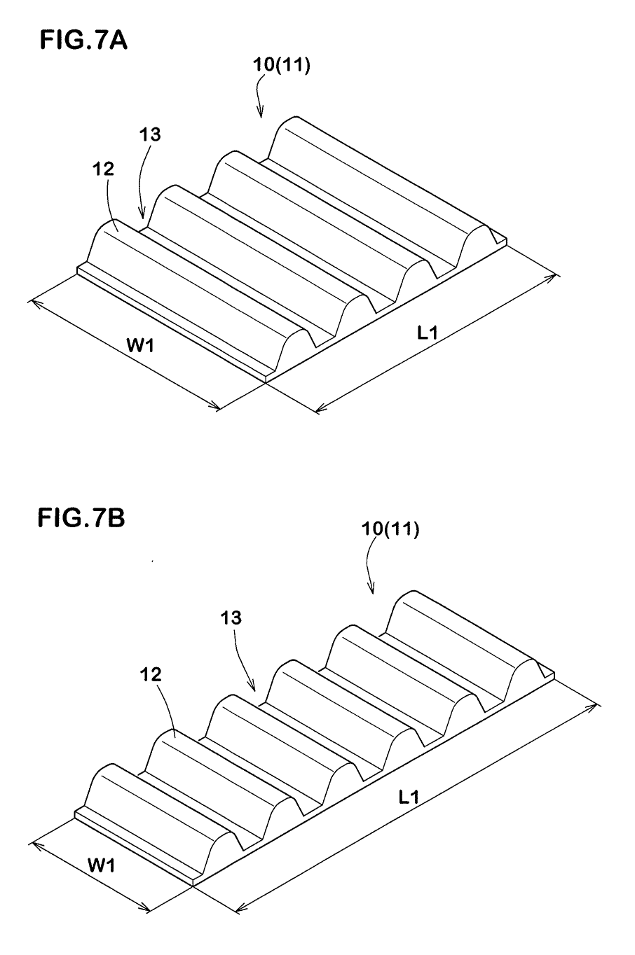

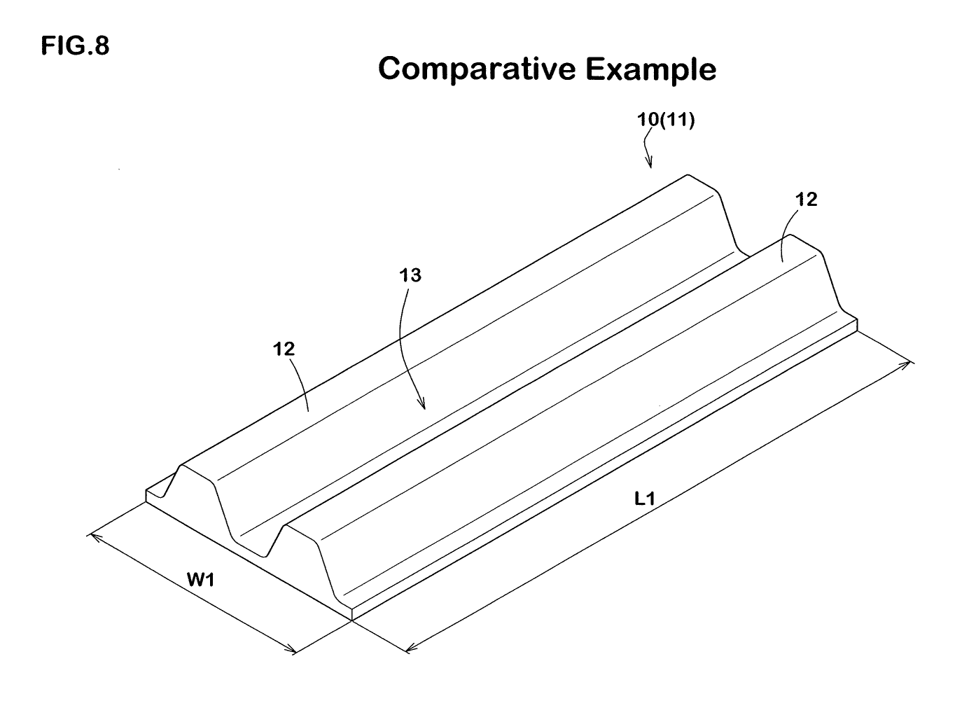

TABLE 1

| | Ref. 1 | Ref. 2 | Ref. 3 | Ex. 1 | Ex. 2 | Ex. 3 | Ex. 4 |
|---|---|---|---|---|---|---|---|
| Sponge member shapes | rectangular | FIG. 8 | rectangular | FIG. 3 | FIG. 3 | FIG. 3 | FIG. 3 |
| | parallelepiped | | parallelepiped | | | | |
| Number of sponge members | 1 | 1 | 1 | 12 | 8 | 4 | 2 |
| Protrusion heights h1 (mm) | 15 | 25 | 15 | 25 | 25 | 25 | 25 |
| (h1 + h2)/2 (mm) | — | 15 | — | 15 | 15 | 15 | 15 |
| Sponge member widths W1 (mm) | 100 | 100 | 10 | 100 | 100 | 100 | 100 |
| Sponge member lengths L1 (mm) | 1950 | 1950 | 1950 | 100 | 100 | 100 | 100 |
| Total volume Va of sponge | 2925 | 2925 | 292.5 | 1800 | 1200 | 600 | 300 |
| members (mm³) | | | | | | | |
| Ratio Va/V (%) | 8.6 | 8.6 | 0.9 | 5.3 | 3.5 | 1.8 | 0.9 |
| Ratio W1/Wa (%) | 56 | 56 | 6 | 56 | 56 | 56 | 56 |
| Layout of sponge members | — | — | — | A | A | A | A |
| Total mass of sponge members (g) | 91 | 91 | 9 | 56 | 37 | 19 | 9 |
| Noise performance [db(A)] | 3.1 | 4 | 0.4 | 6 | 3.1 | 2 | 1 |
| Vibration property | — | — | — | — | small | — | — |
| | Ex. 5 | Ex. 6 | Ex. 7 | Ex. 8 | Ex. 9 | Ex. 10 | Ex. 11 |
| Sponge member shapes | FIG. 3 | FIG. 3 | FIG. 3 | FIG. 3 | FIG. 7A | FIG. 7B | FIG. 3 |
| Number of sponge members | 18 | 18 | 4 | 4 | 4 | 4 | 8 |
| Protrusion heights h1 (mm) | 25 | 25 | 25 | 25 | 25 | 25 | 25 |
| (h1 + h2)/2 (mm) | 15 | 15 | 15 | 15 | 15 | 15 | 15 |
| Sponge member widths W1 (mm) | 160 | 190 | 178 | 160 | 50 | 33.3 | 100 |
| Sponge member lengths L1 (mm) | 100 | 100 | 100 | 100 | 200 | 300 | 100 |
| Total volume Va of sponge | 4320 | 5130 | 1068 | 960 | 600 | 600 | 1200 |
| members (mm³) | | | | | | | |
| Ratio Va/V (%) | 12.8 | 15.2 | 3.2 | 2.8 | 1.8 | 1.8 | 3.5 |
| Ratio W1/Wa (%) | 90 | 107 | 100 | 90 | 28 | 19 | 56 |
| Layout of sponge members | A | A | A | A | A | A | B |
| Total mass of sponge members (g) | 134 | 159 | 33 | 30 | 19 | 19 | 37 |
| Noise performance [db(A)] | 9.5 | 9.7 | 2.8 | 2.7 | 1.8 | 1.3 | 2.9 |
| Vibration property | — | — | — | — | — | — | large |

From the test results, as to noise performance, Ex. 1 is better than the References. In particular, Ex. 1 shows better noise performance than References 1 and 2 even though the total mass of the sponge members is small. The inventors have concluded that this result relies on that the protrusions and the recesses on the inner surface are arranged alternately in the tire circumferential direction with regular pitches. Ex. 2 shows the same noise performance as Ref. 1 even though the total mass of the sponge members is smaller than that of Ref. 1. As to Ex. 4, it is confirmed that when the total volume of the sponge members is 0.9% the tire cavity volume, the noise performance improves. Further, it is confirmed that although Ex. 4 has the same total mass of the sponge members as Ref. 3, it improves noise performance.

In comparison with Ex. 5 and Ex. 6, it is confirmed that the effect of improvement in noise performance in response to increasing of the total mass of the sponge members might reach the peak when the total volume of the sponge members to the tire cavity volume exceeds 12.8%. In comparison with Ex. 2 and Ex. 11, it is confirmed that when the sponge members are arranged in the entire tire circumferential region at the regular pitches, vibration property, as well as noise performance, can be improved in comparison to one in which the sponge members are arranged in the half tire circumferential region at the regular pitches.

What is claimed is:

1. A pneumatic tire comprising:
a tread portion having a tread inner surface provided with a noise damper; and
the noise damper comprising sponge members arranged in a tire circumferential direction,
each sponge member comprising an inner surface facing radially inwardly, wherein
the inner surface of each sponge member comprises protrusions protruding radially inward and recesses recessed radially outward, and
the protrusions and the recesses are arranged alternately.

2. The pneumatic tire according to claim 1, the tread portion further comprising a belt layer, wherein
an axial width of each sponge member is in a range of from 19% to 90% of an axial width of the belt layer.

3. The pneumatic tire according to claim 1, wherein
a maximum thickness of each sponge member is in a range of from 10 to 25 mm.

4. The pneumatic tire according to claim 1, wherein
the sponge members are arranged at regular intervals in the tire circumferential direction.

5. The pneumatic tire according to claim 1, wherein
in each sponge member, differences in height between the protrusions and the recesses are equal to or more than 5 mm.

6. The pneumatic tire according to claim 1, wherein
in each sponge member, the protrusions and the recesses are arranged alternately in the tire circumferential direction.

7. The pneumatic tire according to claim 6, wherein
in each sponge member, the protrusions are continuous over an entire axial width of the sponge member at a constant height.

8. The pneumatic tire according to claim 6, wherein
in each sponge member, the recesses are continuous over an entire axial width of the sponge member at a constant height.

9. The pneumatic tire according to claim 6, wherein
in each sponge member, an arrangement pitch of the protrusions is greater than an axial width of the sponge member.

10. The pneumatic tire according to claim 6, wherein
in each sponge member, at least one of edges of the sponge member in the tire circumferential direction is formed as one of the recesses.

11. A pneumatic tire and rim assembly comprising:
the pneumatic tire of claim 1 and a rim on which the pneumatic tire is mounted, wherein total volume of the sponge members is in a range of from 0.9% to 12.8% of a tire cavity volume enclosed by the pneumatic tire and the rim.

12. The pneumatic tire according to claim 2, wherein
a maximum thickness of each sponge member is in a range of from 10 to 25 mm.

13. The pneumatic tire according to claim 2, wherein
the sponge members are arranged at regular intervals in the tire circumferential direction.

14. The pneumatic tire according to claim 3, wherein
the sponge members are arranged at regular intervals in the tire circumferential direction.

15. The pneumatic tire according to claim 2, wherein
in each sponge member, differences in height between the protrusions and the recesses are equal to or more than 5 mm.

16. The pneumatic tire according to claim 3, wherein
in each sponge member, differences in height between the protrusions and the recesses are equal to or more than 5 mm.

17. The pneumatic tire according to claim 4, wherein
in each sponge member, differences in height between the protrusions and the recesses are equal to or more than 5 mm.

18. The pneumatic tire according to claim 2, wherein
in each sponge member, the protrusions and the recesses are arranged alternately in the tire circumferential direction.

19. The pneumatic tire according to claim 3, wherein
in each sponge member, the protrusions and the recesses are arranged alternately in the tire circumferential direction.

20. The pneumatic tire according to claim 4, wherein
in each sponge member, the protrusions and the recesses are arranged alternately in the tire circumferential direction.
